(19) United States
(12) Patent Application Publication
(10) Pub. No.: US 2016/0116383 A1
(43) Pub. Date: Apr. 28, 2016

(54) Sample Collection Apparatus

(71) Applicant: Endress + Hauser Conducta Gesellschaft für Mess- und Regeltechnik mbH + Co. KG, Gerlingen (DE)

(72) Inventors: Ralf Bernhard, Stuttgart (DE); Joachim Albert, Leonberg (DE); Maike Haslauer, Stuttgart (DE)

(21) Appl. No.: 14/922,254

(22) Filed: Oct. 26, 2015

(30) Foreign Application Priority Data
Oct. 27, 2014 (DE) 10 2014 115 594.7

(51) Int. Cl. G01N 1/34; C02F 1/50; B01D 35/02; G01N 21/78; G01N 1/44; G01N 21/59; G01J 1/42; C02F 1/32; G01N 1/10

(52) U.S. Cl. CPC G01N 1/34; C02F 1/325; C02F 1/50; C02F 1/505; B01D 35/02; G01N 1/10; G01N 1/44; G01N 21/59; G01J 1/42; G01N 21/78; C02F 2303/04; G01N 2201/061; G01N 2201/12; G01N 2021/7783

(57) ABSTRACT

A sample collection apparatus, especially for an analyzer to determine a measurand of a liquid, comprising: a sample collection unit connected to a liquid removal point via a fluid line, a feed device that is designed to transport liquids from the liquid removal point through the fluid line to the sample collection unit, and a filter unit arranged in the flow path from the liquid removal point through the fluid line to the sample collection unit, characterized in that the sample collection apparatus comprises at least one surface or a device effecting a reduction of germs in the liquid transported through the flow path from the filter unit to the sample collection unit.

The invention regards a sample collection apparatus and an analyzer featuring such a sample collection apparatus.

In process measuring technology, for example in chemical, biotechnological, pharmaceutical and processes related to food technology as well as in environmental metrology, automatic samplers and analyzers or analysis devices are frequently used to determine a measurand in a liquid sample. Such samplers or analyzers may, for example, be used for the monitoring and optimization of the cleaning performance in a sewage treatment plant, the monitoring of drinking water or for quality supervision of foodstuffs. Samples automatically taken from the process or a body of water by the sampler at preset times may either be analyzed by an automatic analyzer on site or at a later time in a laboratory. An analyzer may determine the measurand on site. Those devices serve, for example, to measure and monitor the content of a certain substance in the liquid sample, also referred to as an analyte. Analytes may, for example, be ions such as ammonium, phosphate, silicate or nitrate, biological or biochemical compounds, e.g. hormones, or micro-organisms. Other measurands that are determined using analyzers in process measuring technology, especially in water control, are the total oxygen content (TOC) or the chemical oxygen demand (COD). Analyzers or samplers may, for example, be designed as cabinet devices or buoys.

The sample to be analyzed is often treated inside the analyzer by adding one or more reagents, thus provoking a chemical reaction in the liquid sample. The reagents are preferably selected in order to render the chemical reaction verifiable by physical methods, e.g. by optical measurements, by means of potentiometric or amperometric sensors or through a conductivity measurement. The chemical reaction may, for example, cause a coloring or a change of color which may be detected using optical means. In such cases, the intensity of the color is a measure of the measurand to be determined. The measurand may, for example, be determined by photometric or spectrometric means by feeding electromagnetic radiation, such as visible light, from a radiation source into the liquid sample, and receiving it with a suitable receiver after transmission through the liquid sample. The receiver generates a measuring signal that depends on the intensity of the radiation received and which can be used to derive the measurand.

In order to use such methods of analysis in an automated way, e.g. in the industrial sector or for monitoring a sewage treatment plant or a body of water outside, it is desirable to provide an analyzer that automatically executes the required analysis processes.

Automatic analyzers are known in the state of the art. DE 102 22 822 A1, DE 102 20 829 A1 and DE 10 2009 029305 A1, for example, present automatic analyzers to analyze measuring samples that are retrieved from a body of water or a process at a liquid removal point, e.g. an open body of water, a basin or a pipe. Such automatic analyzers are each designed as a cabinet device featuring a control unit, a supply tank for reagents, standard solutions and cleaning liquids, pumps to feed and dosing pumps for the liquid sample and the reagent or reagents into a measuring cell and a measuring sensor for optical measurements on the liquid sample exposed to the reagent or reagents in the measuring cell. The reagents, standard solutions or cleaning liquids are removed from the supply tanks and transported into the measuring cell. Used liquids are transferred from the measuring cell into a waste tank.

In order to remove liquids from the liquid removal point, the relevant analyzers frequently have a sample collection apparatus that includes a fluid line from the liquid removal point to the analyzer as well as a feed device, e.g. a hose pump.

In a number of applications of such analyzers, especially in the environmental sector, the liquids to be analyzed and/or monitored may contain a certain amount of solids that is, for example, noticeable as turbidity. The solids fraction may lead to a falsification of the analysis results for analysis methods that include optical measurements as described above, or even render a measurement impossible. For example, a high particle content in the liquid can make the detection of the coloring of the liquid sample impossible. Larger particles may furthermore clog up the fluid line from the liquid removal point to the analyzer or the fluid lines inside the analyzer. Hence, a sample collection apparatus frequently includes a filter device or a sample preparation device that serves in particular to filter the liquid before it is fed into the analyzer. From the filtrate, a given sample amount is then fed into a processing device of the analyzer and treated and analyzed as described above. A sample preparation device that is designed to rinse the filter from time to time using a cleaning medium including an oxidation agent in order to avoid filter plugging is known from DE 10 2011 088 235 A1.

In some of the applications mentioned, especially in the field of water management, food technology and biotechnology, the samples may contain biological material, especially organisms like algae, bacteria and fungi that may pass through the filter of the sample collection apparatus due to their small size. Should such biological material multiply in the lines of the sample collection apparatus, the consequences may be an accumulation of biological material in the areas downstream of the filter that may include an undesired plugging of the fluid sample feed lines to the analyzer and/or the plugging of fluid sample feed lines arranged inside the analyzer.

Furthermore, it frequently occurs in the applications mentioned above, that the liquid removal point is found at a distance of up to 30 m from the location of the analyzer. The liquid that is removed must therefore be transported over a fairly large distance, a process that requires some time. The bioactivity of the biological material accumulating in the transport line during this time, e.g. due to the metabolic processes of algae, bacteria and fungi, may cause the total composition of the liquid sample during transport and/or after transport into the measuring cell of the analyzer to differ from its composition when it was removed at the removal point.

The purpose of the invention is therefore to describe a sample collection apparatus, especially for an analyzer, that avoids such disadvantages.

The task is solved by a sample collection apparatus according to claim 1. Advantageous embodiments are stated in the dependent claims.

The sample collection apparatus according to the invention, especially for an analyzer to determine a measurand of a liquid, comprises:
a sample collection unit connected to a liquid removal point via a fluid line,
a feed device that is designed to transport liquids from the liquid removal point through the fluid line to the sample collection unit, and
a filter unit arranged in the flow path from the liquid removal point through the fluid line to the sample collection unit, with the sample collection apparatus comprising at least one surface and/or a device effecting a reduction of germs in the liquid transported through the flow path from the filter unit to the sample collection unit.

The sample collection unit may, for example, be a sample provider of an analyzer from which individual liquid samples with preset volumes are extracted for treatment and analysis by the analyzer as described in the introduction. The sample collection unit may also be a tank that houses the liquid and allows it to be taken to a laboratory for further analysis. By arranging a surface or a device that has a germ-reducing effect on the liquid in the liquid transport line from the filter unit to the sample collection unit, the number of biologically active materials, e.g. of organisms such as bacteria, fungi or algae in the liquid is reduced massively, and accumulation in the transport path of the liquid is simply and effectively prevented. Since the materials do not accumulate, the influence their metabolism has on the composition of the liquid during transport from the filter device to the sample collection unit is minimal and therefore may be disregarded. Similarly, plugging of the line serving to transport the liquid to the sample collection unit or, if applicable, of lines in the analyzer found downstream of the sample collection unit in the flow direction of the liquid is effectively prevented.

The surface having a germ-reducing effect on the liquid may, for example, include a material with biocidal effect, especially copper or silver. The surface equipped with the material with biocidal effect may, for example, be the surface of a filter or a filter holder of the filter unit that is in contact with the liquid, or a surface of the fluid line in contact with the liquid, or a surface of the sample collection unit in contact with the liquid.

In another embodiment of the sample collection apparatus, the device having a germ-reducing effect on the liquid may be designed for the addition of a substance with biocidal effect to the liquid. This device may also be used in combination with a surface including material with a biocidal effect.

In one embodiment, the device may include a depot of the substance with biocidal effect that dissolves in the liquid or a supply line for the substance with biocidal effect feeding into the fluid line or the sample collection unit.

In another embodiment, the device having a germ-reducing effect on the liquid may alternatively or additionally contain a heating means to heat the liquid, especially a flow heater.

In another embodiment, the device having a germ-reducing effect on the sample liquid may alternatively or additionally contain a radiation means, especially one emitting UV radiation to irradiate the liquid.

In addition or alternatively, the device may also include an ultra-sound source that is designed to irradiate ultra-sound waves into the liquid.

In this embodiment it is, for example, advantageous that at least one section of the fluid line is made of a material that is transparent for at least a part of the radiation emitted by the radiation source, especially glass or quartz glass, with the radiation source being arranged in such as way with regard to the section of the liquid line that radiation emitted from the radiation source arrives at the liquid running through this section of the fluid line.

The radiation source may alternatively be arranged inside the sample collection unit, especially dipping into the liquid present in the sample collection unit. It is also possible that the sample collection apparatus features another radiation source influencing the liquid in the fluid line in addition to the radiation source arranged inside the sample collection unit, as described in the two paragraphs above.

The filter unit may be arranged on the end of the fluid line close to the liquid removal point, and at least a section of the filter unit may be dipped into the sample liquid present at the liquid removal point.

The invention furthermore comprises an analyzer to determine a measurand of a liquid sample, including a sample collection apparatus according to one of the embodiments as described above, further comprising:
a measuring cell;
at least one liquid tank containing a treatment fluid, especially one or more reagents to treat the liquid sample;
a processing device comprising a feed and dosing apparatus to feed and dose the liquid sample from the sample collection unit and the treatment fluid from the liquid tank in the measuring cell;
a measuring sensor, especially a photometric one, designed to provide at least one measuring signal correlating to the measurand of the liquid sample treated with the treatment fluid and comprised in the measuring cell.

The measurand may, for example, be a concentration of an analyte in the liquid sample.

The invention is in the following explained in further detail on the basis of the embodiments shown in the illustrations. They show:

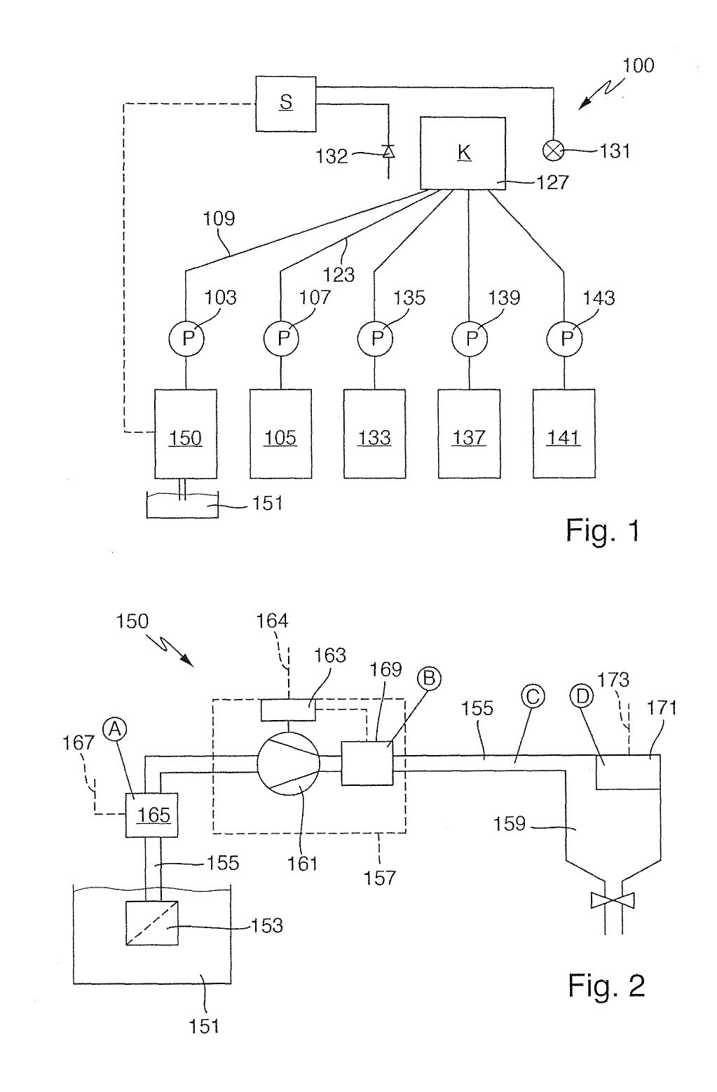

FIG. 1 a schematic view of an analysis apparatus with an automatic analyzer and a sample collection apparatus;

FIG. 2 a schematic view of a sample collection apparatus.

In FIG. 1, is shown a schematic view of an analysis apparatus with an analyzer 100 to determine a measurand in a sample of a liquid. The analyzer 100 comprises several supply tanks 133, 137 and 141, a processing device with a plurality of pumps, 135, 139 and 143 to feed and dose the liquids contained in the supply tanks 133, 137 and 141, and fluid lines that connect the supply tanks 133, 137, 141 with a measuring cell 127. In addition, the analyzer 100 features a waste tank 105 that is also connected to the measuring cell 127 via a pump 107. The pumps 107, 135, 139 and 143 may, for example, be membrane pumps, piston pumps, especially syringe pumps, or peristaltic pumps. The analyzer 100 further comprises a sample collection apparatus 150 with a sample collection unit. The sample collection apparatus 150 is designed in such as a way to obtain a liquid at a liquid removal point 151 of a process or a body of water, filter it and collect it in the sample collection unit. The sample collection unit serves as a sample presenter for the analyzer 100. A liquid sample with a preset volume is taken from the sample presenter to conduct an analysis. The sample collection unit is connected to the measuring cell 127 via a supply line 109. The pump 103 is used in order to feed and dose the liquid samples into the measuring cell 127, which may, for example, be designed as a membrane pump, a piston pump, especially a syringe pump or a peristaltic pump like the other pumps 107, 135, 139 and 143.

In order to capture the measurand that is to be determined by the analyzer 100, the analyzer 100 furthermore comprises an optical measuring receiver that features a radiation source 131 emitting the measuring radiation and a receiver 132 that are arranged in such a way to the measuring cell 127 that the measuring radiation passes through a liquid sample contained in the measuring cell 127 and the measuring radiation transmitted through the sample then arrives at the receiver 132.

The analyzer 100 can be run in full automatic mode. For this purpose, it is equipped with a control unit S that in the example shown here also fulfills the function of an evaluation unit, especially the determination of a measurand based on a measuring value captured with the measuring sensor. The control unit S in the example shown here is also used to control the sample collection apparatus 150.

The control unit S comprises a data processing unit with a memory that has a memory providing one or several operating programs serving to control the analyzer 100 and/or the control of the sample collection apparatus 1 as well as, if required, the evaluation of the measuring signal delivered by the optical measuring sensor 131, 132. The data processing apparatus may also have an input device to allow an operator to enter commands or parameters and/or an interface to receive commands, parameters or other data from a superior unit. In addition, the control unit S may also have an output device to output data, especially measuring data or operating information to a user and for the output of data to the superior unit via an interface. The control unit S is connected to the drives of the pumps 103, 107, 135, 139, 143 and with valves (not shown in detail herein) to automatically operate those to transport the liquids from the sample collection unit and the liquid tanks, 133, 137 and 141 into the measuring cell 127. The control unit S is furthermore linked to the measuring sensor to control it and determine the measuring variable to be detected from the measuring signals of the receiver 132.

The supply tank 141 may contain a reagent that is mixed with the sample removed from the sample collection unit to treat it. If, for example, the measurand to be determined is the concentration of an analyte in the liquid, the reagent may be selected to react with the analyte generating a colored reaction product. The intensity of the coloring is a measure of the concentration to be determined. The wave length of the measuring radiation emitted from the radiation source 131 is coordinated with the coloring of the reaction product in this case and is evaluated accordingly by the receiver 132 and/or the control unit S. Instead of a single reagent as in the example shown here, several reagents may be used depending on the measurand to be determined. In this case, the analyzer 100 has an appropriate number of supply tanks for the reagents needed.

During measuring operation of the analyzer, the control unit S first doses a pre-set amount of the liquid contained in the sample collection unit into the measuring cell 127 as the sample to be analyzed. At the same time or subsequently, the control unit S controls the pump 143 in order to transport a given amount of the reagent contained in supply tank 141 into the measuring cell. Hence, the measuring cell 127 in the example described here also serves as a mixing cell where the liquid sample and the reagent are mixed. However, other embodiments are also possible, in which the reagent or several reagents are mixed with one another before the liquid sample is dosed into the measuring cell 127.

In order to capture the measurand of the treated liquid sample contained in the measuring cell, the control unit S operates the measuring sensor 131, 132 and evaluates the measuring signal output by the measuring sensor 131, 132. The measurand determined from the measuring signal by the control unit S may be saved in a data memory of the control unit S, and output to a superior unit via an interface and/or a display on the control unit S.

Once the measurand has been determined, the measuring cell 127 is emptied by transporting the used sample in the measuring cell to the waste tank 105 using the pump 107. The analyzer 100 has other supply tanks 133, 137 that may include standard solutions for calibration and/or cleaning liquids. Thanks to the pumps 135, 139 associated to the supply tanks 133, 137, those solutions may be transported to the measuring cell.

After one or several measuring cycles that are conducted, a calibration of the analyzer 100 may be executed by feeding a standard solution from the supply tank 137 to the measuring cell 127. The standard solution is treated in the measuring cell 127 with the reagent like a “real” liquid sample taken from the sample collection unit, with said reagent being transported from the supply tank 141 to the measuring cell 127 by means of the pump 143. A measuring value of the measurand is photometrically determined by means of the measuring sensor 131, 132 and, if necessary, the analyzer 100 is adjusted on the basis of the measuring value.

FIG. 2 shows the sample collection apparatus 150 in detail in a schematic view. The sample collection apparatus 150 includes a filter device 153 which at least in some sections dips into the liquid present at the liquid removal point 151 during operation. The filter device 153 is connected to a sample collection unit 159 via a fluid line 155 and a feed device 157. The feed device 157 includes a pump 161 that is designed in such a way as to transport a liquid taken from the liquid removal point 151 through the fluid line 155. The pump 161 may, for example, be a hose pump. The filter device may include a plastic, metal or ceramic filter with a pore size of 0.5 to 50 μm serving to withhold solid particles present in the liquid.

The feed device 157 has a control unit 163 which is designed to control the pump 161. The control device 163 may optionally be connected to a superior control unit, e.g. the control unit S of the analyzer 100 shown in FIG. 1, via an interface 164 for communication. The control comprises a data processing unit, especially including a microprocessor which has a memory containing an operating program serving to control the feed unit 157 which the data processing device is able to execute. The sample collection unit 159 serves to receive the liquid taken from the liquid removal point 151 and as a sample presenter from which an automatic analyzer, e.g. the analyzer 100 described on the basis of FIG. 1, removes samples to determine the measurand.

The sample collection apparatus 150 may have one or more surfaces or devices having a germ-reducing effect on the liquid. Possible positions where the germ-reducing surfaces or devices may be installed have been marked with the capital letters A, B, C and D in FIG. 2.

Basically, a germ reduction of a liquid or a liquid or watery sample may be done in several ways: One option is a thermal treatment of the liquid, with a temperature of more than 80° C., preferably more than 100° C. being advantageous. Another option is to treat the liquid with UV radiation which renders the biological substances contained therein harmless. A treatment of the liquid with ultra-sound may also serve to remove germs. Alternatively it is possible to add a substance with biocidal effect to the liquid. A substance with biocidal effect is a substance or a mixture of substances that includes one or more agents that is and/or are intended to destroy, deter, render harmless or prevent an effect or biologically active substances, especially organisms such as fungi, algae and bacteria contained in the liquid, or to fight them in another way. Such substances with biocidal effect have a germ-reducing effect in the sense of the invention. A substance with biocidal effect may, for example, be introduced into the liquid with a dosing pump or with a self-dissolving biocide depot. Surfaces on the sample collection apparatus 150 that touch the liquid may also feature a substance with biocidal effect, especially by making components of the sample collection apparatus 150 from a material with biocidal effect or by applying a coating to them that includes a substance with biocidal effect.

A surface touching the liquid with biocidal and/or germ-reducing effect may be installed at position A, i.e. in the flow path of the liquid directly downstream of the filter unit 153. For example, a filter holder that attaches the filter to the fluid line 155 may be made of copper or silver or be coated in copper or silver. The metallic copper or silver has a germ-reducing effect on the liquid flowing through the filter holder.

In the present example, a dosing device 165 has been inserted into the fluid line 155 which is designed to feed a substance with biocidal effect, e.g. a solution of biocidal chemicals, which may, for example, include a silver salt, silver nano particles and/or a chlorine solution in a controlled way. The dosing unit 165 includes a liquid tank that includes the substance with biocidal effect present in the liquid, as well as a dosing pump that may, for example, be designed as a syringe pump. The dosing unit 165 may have its own control unit that is designed to add the substance with biocidal effect to the liquid flowing through the fluid line according to a given schedule, either from time to time or continually. The control may also be connected to a superior control unit, e.g. the control unit S of the analyzer 100 described on the basis of FIG. 1 via an interface 167 for communication. The amount of the substance with biocidal effect that is to be added during every temporal unit may, for example, be set depending on the composition of the liquid found at the liquid removal point 151 or from the flow velocity of the liquid through the fluid line 155. For this purpose, the superior control unit may configure or parametrize the control of the dosing unit 165 or transfer control commands to the controls of the dosing device 165.

In an alternative example, it is also possible that a depot of a substance with biocidal effect is arranged inside the fluid line 155 which slowly dissolves in the liquid flowing through the fluid line. One example of this is silver wool comprising finely distributed mechanical silver or tablets or a powder containing silver ions that release silver or silver ions respectively slowly over a longer period of time such as weeks or months.

A sterilization unit 169 is installed as position B, i.e. within the feed unit 157, especially downstream (in flow direction as shown here) or directly before the pump 161. The sterilization unit for the thermal treatment of the liquid transported through the liquid line 155 may, for example, include a flow heater through which the liquid transported through the fluid line 155 is led, or a microwave heating. The flow heater may cyclically also execute a self-sterilization cycle by heating to much higher temperatures in times without sample flow. In an alternative embodiment, the sterilization device 169 may feature a section of the line that is inserted into the fluid line 155 and is transparent for UV radiation as well as a UV source of light that is designed to irradiate UV light through the transparent line section into the fluid flowing through it.

In addition or alternatively, a dosing unit may be arranged in the fluid line 155 at position B to sterilize the liquid flowing through the fluid line 155 which is designed in a way analogous to the dosing device 165 already described.

The section of the liquid line 155 running between the feed unit 157 and the sample collection unit 159 may be up to 30 m long in many applications in industrial processes, e.g. in sewage treatment plants. Within this line section, position C, a surface touching the liquid may comprise a substance with biocidal effect. For example, the fluid line 155 itself may be made of a substance with biocidal effect at least in part, or be coated with a coating including a substance with biocidal effect. It is also possible to place a copper or silver wire with biocidal effect into the fluid line 155.

In the example shown here, a UV radiation source 171 is arranged at position D within the sample collection unit 159 which is designed to irradiate UV radiation into the liquid flowing into the sample collection unit 159 or received into the sample collection unit 159. The walls of the sample collection unit 159 may be designed to reflect the UV radiation back into the liquid, and/or to prevent the exit of UV radiation from the sample collection unit 159. The UV radiation source 171 may include a control device that may be connected to a superior control device via an interface 173 for communication, e.g. the control unit S of the analyzer 100 described on the basis of FIG. 1, and which serves to control the UV radiation source.

Alternatively or additionally, a biocidal substance may be arranged in the sample collection unit 159 as a slowly dissolving depot or a metal body with biocidal effect. It is advantageous to arrange the biocidal substance in an area of the sample collection unit 159 that is usually covered by liquid.

A number or alternative embodiments of the sample collection apparatus according to the invention can be envisaged. The sample collection apparatus may especially feature only one of the surface with biocidal effect as described on the basis of FIG. 2 and/or devices or combinations of two or more of those surfaces and/or devices. The sample collection unit 159 may, if it does not serve as the sample presenter for an automatic analyzer, also be designed as a, preferably lidded, tank that serves to keep the liquid obtained at the liquid removal point and for the transport of the liquid to a laboratory for a further analysis of the liquid.

1-11. (canceled)

12. A sample collection apparatus, especially for an analyzer to determine a measurand of a liquid, comprising:
a sample collection unit connected to a liquid removal point via a fluid line;
a feed device that is designed to transport liquids from the liquid removal point through the fluid line to the sample collection unit, and
a filter unit arranged in the flow path from the liquid removal point through the fluid line to the sample collection unit, wherein:
said sample collection apparatus comprises at least one surface or a device effecting a reduction of germs in the liquid transported through the flow path from said filter unit to said sample collection unit.

13. The sample collection apparatus according to claim 12, wherein:
the surface effecting a reduction of germs in the liquid includes a material with biocidal effect, especially copper or silver.

14. The sample collection apparatus according to claim 13, wherein:
the surface equipped with the material with biocidal effect is the surface of a filter or a filter holder of said filter unit that is in contact with one of: the liquid, or a surface of the fluid line in contact with the liquid, or a surface of the sample collection unit in contact with the liquid.

15. The sample collection apparatus according to claim 12, wherein:
said device effecting a reduction of germs in the liquid is designed for the addition of a substance with biocidal effect to the liquid.

16. The sample collection apparatus according to claim 15, wherein:
said device includes a depot of the substance with biocidal effect that dissolves in the liquid or a supply line for feeding the substance with biocidal effect into the fluid line or said sample collection unit.

17. The sample collection apparatus according to claim 12, wherein:
said device has a germ-reducing effect on the liquid containing a heating means to heat the liquid, especially a flow heater.

18. The sample collection apparatus according to claim 12, wherein:
said device effecting a reduction of germs in the liquid includes a radiation source, especially emitting UV radiation to irradiate the liquid.

19. The sample collection apparatus according to claim 18, wherein:
at least one section of the fluid line is made of a material that is transparent for at least a part of the radiation emitted by the radiation source, especially glass or quartz glass; and
said radiation source is arranged in such as way with regard to the section of the liquid line that radiation emitted from said radiation source arrives at the liquid flowing through this section of the fluid line.

20. The sample collection apparatus according to claim 18, wherein:
said radiation source is arranged inside said sample collection unit, especially dipping into the liquid present in said sample collection unit.

21. The sample collection apparatus according to claim 12, wherein:
said filter unit is arranged at the end of the fluid line close to the liquid removal point; and
at least a section of the filter unit is dipped into the sample liquid present at the liquid removal point.

22. An analyzer to determine a measurand, for example a concentration of an analyte, of a liquid sample, comprising a sample collection apparatus according to claim 12, further comprising:
a measuring cell;
at least one liquid tank containing a treatment fluid, especially one or more reagents, to treat the liquid sample;
a processing device comprising a feed and dosing apparatus to feed and dose the liquid sample from said sample collection unit and the treatment fluid from the liquid tank in said measuring cell; and
a measuring sensor, designed to provide at least one measuring signal correlating to the measurand of the liquid sample treated with the treatment fluid and comprised in said measuring cell.

23. The analyzer according to claim 22, wherein:
said measuring sensor is a photometric one.
